(19) United States
(12) Patent Application Publication
(10) Pub. No.: US 2012/0044614 A1
(43) Pub. Date: Feb. 23, 2012

(54) ELECTROLYTIC SOLUTION FOR ELECTRIC DOUBLE LAYER CAPACITOR, ELECTRIC DOUBLE LAYER CAPACITOR USING THE SAME, AND MANUFACTURING METHOD THEREFOR

(76) Inventors: Tomohiro HOMMO, Chiba-shi (JP); Roy SATO, Chiba-shi (JP); Tomoko OIKAWA, Chiba-shi (JP); Tsuneaki TAMACHI, Chiba-shi (JP); Isamu SHINODA, Chiba-shi (JP); Sunji WATANABE, Chiba-shi (JP)

(21) Appl. No.: 13/212,462

(22) Filed: Aug. 18, 2011

(30) Foreign Application Priority Data
Aug. 18, 2010 (JP) 2010-183198
Jun. 21, 2011 (JP) 2011-137328

(51) Int. Cl. H01G 9/155; H01G 9/022

(52) U.S. Cl. 361/502; 252/62.2

(57) ABSTRACT

Provided are an electrolytic solution for an electric double layer capacitor capable of providing an electric double layer capacitor having stable quality, an electric double layer capacitor using the electrolytic solution, and a manufacturing method for the electric double layer capacitor. The electrolytic solution includes a supporting electrolyte, sulfolane, and a linear sulfone. It is preferred that the electrolytic solution further include an organic fluorine compound. Further, it is preferred that the supporting electrolyte contain 5-azoniaspiro[4.4]nonane tetrafluoroborate, and the content of 5-azoniaspiro[4.4]nonane tetrafluoroborate be 1.5 to 3.6 mol/dm³.

### RELATED APPLICATIONS

This application claims priority under 35 U.S.C. §119 to Japanese Patent Application Nos. 2010-183198 filed on Aug. 18, 2010 and 2011-137328 filed on Jun. 21, 2011, the entire contents of which are hereby incorporated by reference.

### BACKGROUND OF THE INVENTION

1. Field of the Invention

The present invention relates to an electrolytic solution for an electric double layer capacitor, an electric double layer capacitor using the electrolytic solution, and a manufacturing method for the electric double layer capacitor.

2. Description of the Related Art

An electric double layer capacitor includes a pair of polarizable electrodes, a separator interposed between the pair of polarizable electrodes, and an electrolytic solution, with which the pair of polarizable electrodes and the separator are impregnated, in a housing container sealed with a lid and a container body. In various small-sized electronic devices, such as mobile phones, PDAs, and portable game machines, such electric double layer capacitor is used as a backup power source for memory, a backup power source for clock functions, and the like. As this kind of electric double layer capacitor, an electric double layer capacitor of a button type having a disc shape is widely used.

The electric double layer capacitor of a button type has a structure in which a container body is caulked and sealed with a lid. Thus, the air tightness of the capacitor is not always satisfied. Moisture or the like may be easily permeated in the inside of the capacitor in humid conditions, or the like. Thus, the permeated moisture causes deterioration in polarizable electrodes and an electrolytic solution, with the result that it is difficult to store and use the capacitor for a long period of time. In addition, further requests for miniaturization and thickness reduction have been placed on the electric double layer capacitor.

In order to deal with those problems, an electric double layer capacitor of a chip type having a rectangular shape has been proposed (see, for example, Japanese Patent Application Laid-open No. 2001-216952).

In general, the electric double layer capacitor of a chip type is manufactured by housing polarizable electrodes, a separator, and an electrolytic solution in a container body provided with a metal ring on the periphery of an opening, closing the opening of the container body with a lid called a sealing plate, and joining the lid and the container body together by application of heat. The electric double layer capacitor described in Japanese Patent Application Laid-open No. 2001-216952 is excellent in air tightness of the inside of the housing container because the metal ring placed on the periphery of the opening of the container body is joined with the lid by a soldering material, such as nickel or silver solder. This joining method uses a heating temperature of 300° C. or more. In addition, for example, the method of joining the lid and the container body may be one in which a metal-plated lid and a metal ring are used, the opening of a container body is sealed with the lid, and heating is performed up to a temperature at which the metal plating can be molten. This joining method uses a heating temperature of 800 to 1,500° C. when the metal plating is nickel plating.

### SUMMARY OF THE INVENTION

In general, an electrolytic solution used for an electric double layer capacitor is a symmetric or asymmetric linear alkyl carbonate solvent, such as ethyl methyl carbonate (EMC) or dimethyl carbonate (DMC), which has a low melting point and a low viscosity, to reduce internal resistance while allowing polymerizable electrodes and a separator to be favorably impregnated with the electrolytic solution. EMC and DMC have poor heat resistance because of comparatively low boiling points (less than 200° C.). Thus, EMC and DMC are easily vaporized to cause high vapor pressure or bumping when the lid and the container body of the electric double layer capacitor of a chip type are joined together. Therefore, the use of EMC and DMC may have some disadvantages. For example, the remaining amount of an electrolytic solution may vary widely and the quality, such as service capacity, of the electric double layer capacitor may be unstable. In addition, as the solvent has a low boiling point, an increase in vapor pressure of the electrolytic solution leads to an increase in internal pressure when the lid and the container body are welded together. As a result, the housing container may be damaged.

Further, the electric double layer capacitors of a button type and a chip type can be surface-mounted on a substrate by reflow soldering. As the electric double layer capacitor is heated at about 240 to 260° C. by reflow soldering, an increase in vapor pressure may make the sealed portion weak. Thus, the leakage of the electrolytic solution may occur and the quality of the electric double layer capacitor may become unstable.

In addition, the electric double layer capacitor is often used continuously under the application of a voltage of 2.0 V or more or a high voltage of 3.0 V or more from a main power source. When a high voltage is applied to the electrolytic solution, the degradation of a solute or solvent of the electrolytic solution is accelerated and facilitates a decrease in function of the electrolytic solution. In particular, when an ambient temperature at which the voltage is applied is high, a significant decrease in function occurs. Therefore, the high-voltage applicable electric double layer capacitor requires an increasing amount of the electrolytic solution. However, an increasing amount of the electrolytic solution may facilitate a leakage of the electrolytic solution when the lid and the container body are joined by welding or reflow soldering. As a result, the quality of the electric double layer capacitor may become unstable.

Therefore, the present invention intends to provide an electrolytic solution for an electric double layer capacitor capable of providing an electric double layer capacitor having stable quality, an electric double layer capacitor using the electrolytic solution, and a manufacturing method for the electric double layer capacitor.

An electrolytic solution for an electric double layer capacitor according to the present invention includes a supporting electrolyte, sulfolane, and a linear sulfone.

It is preferred that the electrolytic solution for an electric double layer capacitor according to the present invention further include an organic fluorine compound. It is preferred that the supporting electrolyte contain 5-azoniaspiro[4.4]nonane tetrafluoroborate, and the content of 5-azoniaspiro[4.4]nonane tetrafluoroborate be 1.5 to 3.6 mol/dm³.

An electric double layer capacitor according to the present invention includes a housing container, including a lid and a container body for sealing the housing container, the housing container including: at least one pair of polarizable electrodes, which are arranged opposite to each other via a separator; and the electrolytic solution according to the present invention.

It is preferred that the housing container have a percentage of a void of 10 to 30 vol %, which is represented by the ratio [(volume of void in housing container)/(capacity of housing container)]×100, and it is preferred that the pair of polarizable electrodes include an anode side electrode and a cathode side electrode, the anode side electrode having a surface area larger than that of the cathode side electrode.

A manufacturing method for the electric double layer capacitor according to the present invention is a manufacturing method for the electric double layer capacitor according to the present invention, including an electrode arrangement step of arranging a pair of polarizable electrodes opposite to each other via a separator in a container body; an injection step of injecting an electrolytic solution into the container body; and a sealing step of sealing the container body with a lid after the injection step.

It is preferred that the sealing step include welding the lid and the container body together. It is preferred that the manufacturing method further include a preheating step of heating the electrolytic solution at a temperature of 200° C. or more and less than 900° C. for 1 msec or more after the injection step and before the sealing step. It is more preferred that the preheating step include heating by applying power to the lid.

According to the present invention, the electric double layer capacitor having stable quality can be obtained.

### BRIEF DESCRIPTION OF THE DRAWINGS

In the accompanying drawings:

FIG. 1 is a cross-sectional diagram of an electric double layer capacitor according to an embodiment of the present invention; and

FIG. 2 is a cross-sectional diagram of an electric double layer capacitor according to an embodiment of the present invention.

### DETAILED DESCRIPTION OF THE PREFERRED EMBODIMENTS

Hereinafter, an electric double layer capacitor according to one embodiment of the present invention is described with reference to the drawings.

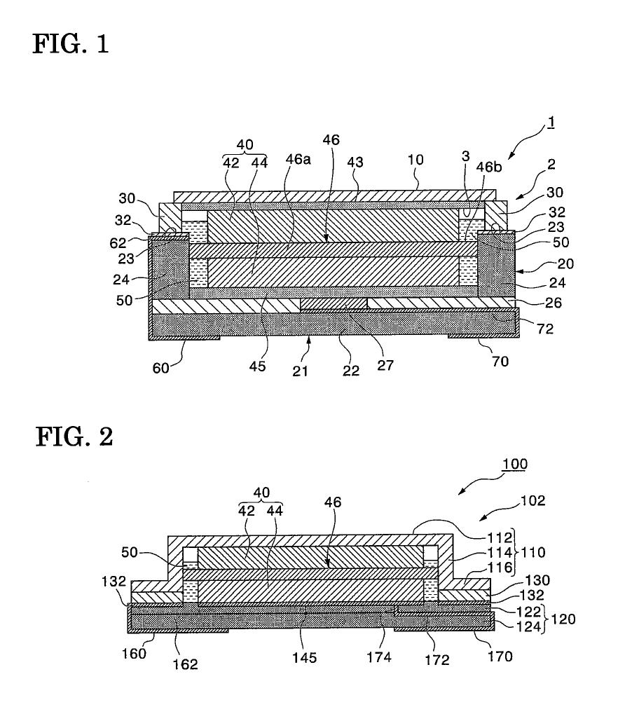

An electric double layer capacitor 1 shown in FIG. 1 is of the so-called chip type having a substantially rectangular shape of 2 to 3 mm in length, 2 to 3 mm in width, and 0.2 to 1 mm in height. The electric double layer capacitor 1 includes a pair of polarizable electrodes 40, i.e., an anode side electrode 42 and a cathode side electrode 44, which are arranged opposite to each other via a separator 46, and an electrolytic solution 50 in a housing container 2. In addition, both the polarizable electrodes 40 and the separator 46 are impregnated with the electrolytic solution 50 in the housing container 2.

The housing container 2 includes a container body 20 having a square tube shape with a closed bottom, a lid 10, which is a flat sealing plate, for sealing the opening of the container body 20, and a seal ring 30 placed on the periphery of the opening of the container body 20. The container body 20 is sealed with the lid 10 through the seal ring 30. The housing container 2 has a wall thickness of, for example, 0.15 to 0.25 mm but not particularly limited thereto.

The container body 20 includes a bottom wall portion 21 and a side wall portion 24. The bottom wall portion 21 includes a flat substrate 22 having a substantially rectangular shape in a planer view and an intermediate layer 26 formed on one side of the substrate 22. The side wall portion 24 is a square cylindrical component vertically arranged on the periphery of the bottom wall section 21.

On almost the center of the intermediate layer 26, a protective layer 27 passing through the intermediate layer 26 is provided.

The seal ring 30 is joined with an upper end surface 23 of the side wall portion 24, which is the periphery of the opening of the container body 20, by a soldering material 32.

The anode side electrode 42 has only to be electrically connected to the lid 10, and for example, is preferably adhered to the lid 10 through an anode collector 43 formed of a conductive resin adhesive including amorphous carbon or graphite as a conductive filler. The cathode side electrode 44 is electrically connected to a cathode collector 45 which is similar to the anode collector 43.

The external bottom surface and the external side surface of the container body 20 are provided with a first external terminal 60 and a second external terminal 70. The first external terminal 60 is connected to a first metal layer 62 arranged between the soldering material 32 and the side wall portion 24. Thus, the first external terminal 60 is electrically connected to the anode side electrode 42 via the first metal layer 62, the soldering material 32, the seal ring 30, and the anode collector 43. The second external terminal 70 is connected to a second metal layer 72. Here, the second metal layer 72 is arranged between the substrate 22 and the intermediate layer 26 and connected to the protective layer 27. Thus, the second external terminal 70 is electrically connected to the cathode side electrode 44 through the second metal layer 72, the protection layer 27, and the cathode collector 45.

The electrolytic solution 50 is prepared by dissolving a supporting electrolyte in a nonaqueous solvent that contains sulfolane and a linear sulfone. Sulfolane (tetrahydrothiophene 1,1-dioxide) and the linear sulfone are solids at normal temperature (25° C.), which serve as a nonaqueous solvent of a liquid (ionic liquid) when they are mixed together. The polarizable electrodes 40 and the separator 46 may be impregnated with the electrolytic solution 50 containing the nonaqueous solvent.

The volume of the electrolytic solution 50 in the housing container 2 is not particularly limited. However, for example, it may be determined so that the percentage of a void in the housing container 2, which is represented by the following equation (i), is preferably 10 to 30 vol %, more preferably 15 to 30 vol %. If it is less than 10 vol %, the electric double layer capacitor 1 may receive any damage on the housing container 2 as a result of a change of inner pressure due to expansion of the electrolytic solution 50 during the production process. If it exceeds 30 vol %, the service capacity tends to decrease within a short time. This is considered to be based on the following causes. For example, when it is charged with a voltage of more than 3 V, the supporting electrolyte and nonaqueous solvent of the electrolytic solution 50 are decomposed. Thus, it results in a decrease in remaining amount of the electrolytic solution 50 in the separator 46 between the anode side electrode 42 and the cathode side electrode 44 (i.e., between the electrodes). In particular, a remarkable decrease in amount of the electrolytic solutions 50 around the surface of the separator 46 occurs. When the electrolytic solution 50 around the surface of the separator 46 remarkably decreases, the cross-sectional area of the liquid path formed between the electrodes decreases. Thus, an excess voltage is generated accompanying the concentration of current in discharge and charge. This excess voltage further accelerates the decomposition of the supporting electrolyte or the nonaqueous solvent, and the electrolytic solution 50 deteriorates remarkably. Further, the decomposed component produced by the decomposition of the electrolytic solution 50 may form a film on the surface of the separator 46, and may further accelerate an increase in resistance as well as an increase in excess voltage, thereby causing a decrease in service capacity within a short period of time.

The percentage of a void in the housing container 2 can be controlled, for example, by adjusting the injection volume of the electrolytic solution 50 in an injection step described later, mixing the electrolytic solution 50 with a solvent having a low boiling point (less than 200° C.) or water in advance, or vaporizing the solvent having a low boiling point in a preheating step described later.

Percentage of void (vol %)=[(Volume of void in housing container)/(Capacity of housing container)]×100 (i)

In the above-mentioned equation (i), the term “Capacity of housing container” means the volume of a space enclosed by the lid 10 and the container body 20. The term “Volume of void of housing container” means the volume of a void 3 generated in the inside of the housing container 2.

Sulfolane is a substance represented by the following formula (a), and has a boiling point (bp) of 285° C.

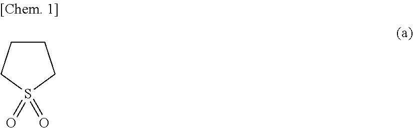

The content of sulfolane in the nonaqueous solvent can be determined taking into consideration of the heating condition in the preheating step or the sealing step in the manufacturing process of the electric double layer capacitor 1, the heating condition during use, and the like. For example, the content of the sulfolane in the nonaqueous solvent is preferably 25 to 90 mass %, more preferably 50 to 80 mass %, still more preferably 55 to 70 mass %. If it is less than 25 mass %, the viscosity of the electrolytic section 50 increases and the fluidity thereof decreases. Thus, for example, in the injection step described later, the injection volume of the electrolytic solution 50 varies, causing an unstable remaining amount of the electrolytic solution 50. As a result, the electric double layer capacitor 1 having stable quality is hardly obtained. If it exceeds 90 mass %, the amount of the supporting electrolyte in the nonaqueous solvent becomes insufficient. As a result, a sufficient service capacity of the electric double layer capacitor 1 may be hardly obtained. If it exceeds 90 mass %, further, the content of the linear sulfone or supporting electrolyte becomes insufficient. As a result, the service capacity of the electric double layer capacitor 1 under a low-temperature environment (−20° C. or less) may be hardly obtained.

The linear sulfone has a structure in which a total of two linear or branched aliphatic alkyl groups are bonded to sulfur (S) in tetrahydrothiophene 1,1-dioxide. The two alkyl groups that construct the linear sulfone may be identical or different from each other. The linear sulfone can be determined by taking into consideration of the desired property of the electrolytic solution 50, such as heat resistance. Preferred examples of the linear sulfone include dimethyl sulfone (DMS) represented by the following formula (b) and ethyl methyl sulfone (EMS) represented by the following formula (c). Of those, ethyl methyl sulfone, which has an asymmetric alkyl group and thus has a low melting point, is preferred.

One kind of those linear sulfones may be used alone, or two or more kinds thereof may be used in combination.

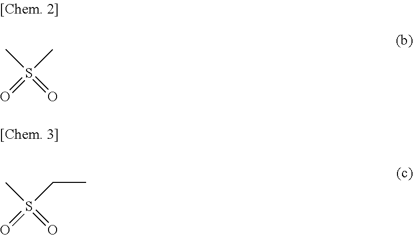

The content of the linear sulfone in the nonaqueous solvent can be determined taking into consideration of a heat condition in the preheating step or the sealing step in the manufacturing process of the electric double layer capacitor 1, the heating condition during use, and the like. For example, the content of the linear sulfone in the nonaqueous solvent is preferably 10 to 80 mass %, more preferably 10 to 50 mass %, still more preferably 15 to 25 mass %. If it is less than 10 mass %, the nonaqueous solvent solidifies and the viscosity increases, causing insufficient fluidity. For example, it leads to a difficulty in injection of the electrolytic solution 50 in the injection step described later. Therefore, the amount of the electrolytic solution 50 becomes insufficient, and the performance of the electric double layer capacitor 1 cannot be sufficiently secured. Thus, it becomes difficult to obtain the electric double layer capacitor 1 having stable quality. If it exceeds 80 mass %, the nonaqueous solvent solidifies and the viscosity increases, causing insufficient fluidity. It leads to a difficulty in injection of the electrolytic solution 50 in the injection step described later. Therefore, the amount of the electrolytic solution 50 becomes insufficient, and the performance of the electric double layer capacitor 1 cannot be sufficiently secured. Thus, it becomes difficult to obtain the electric double layer capacitor 1 having stable quality.

The total content of the sulfolane and the linear sulfone in the nonaqueous solvent can be determined taking into consideration of the heat condition in the preheating step or the sealing step in the manufacturing process of the electric double layer capacitor 1, the heating condition during use, and the like. For example, the total content of the sulfolane and the linear sulfone in the nonaqueous solvent is preferably 40 to 90 mass %, more preferably 65 to 90 mass %, still more preferably 75 to 85 mass %. If it is less than 40 mass %, the viscosity of the electrolytic section 50 increases and the fluidity thereof decreases. Thus, for example, in the injection step described later, the injection volume of the electrolytic solution 50 varies, causing an unstable remaining amount of the electrolytic solution 50. As a result, the electric double layer capacitor 1 having stable quality is hardly obtained. If it exceeds 90 mass %, the amount of the supporting electrolyte in the nonaqueous solvent becomes insufficient. As a result, a sufficient service capacity of the electric double layer capacitor 1 may be hardly obtained. If it exceeds 90 mass %, further, the content of the supporting electrolyte becomes insufficient. As a result, the service capacity under a low-temperature environment (−20° C. or less) may be hardly obtained.

With regard to the ratio of the contents of sulfolane and the linear sulfone in the nonaqueous solvent, as the content of sulfolane is larger, heat resistance is improved more greatly. On the other hand, if the content of the linear sulfone is too small, the nonaqueous solvent does not become an ionic liquid and the fluidity of the nonaqueous solvent becomes insufficient. Thus, the ratio of the contents of sulfolane and the linear sulfone can be determined taking into consideration of the heat condition in the production of the electric double layer capacitor 1, the usage condition, and the like. For example, the ratio sulfolane:linear sulfone is preferably 1:9 to 9:1 (mass ratio), more preferably 5:5 to 9:1, still more preferably 7:3 to 9:1.

The nonaqueous solvent can contain another solvent (arbitrary solvent) in addition to sulfolane and the linear sulfone if required. The type of the arbitrary solvent can be determined taking into consideration of the desired property of the electrolytic solution 50, such as heat resistance and viscosity, and is preferably an aprotic polar solvent having an oxygen atom in the structure. Examples of the arbitrary solvent include: linear esters including aliphatic monocarboxylic acid esters, e.g., formic acid esters such as ethyl formate, propyl formate, and n-propyl formate, propionic acid esters such as methyl propionate and ethyl propionate, and butyric acid esters such as methyl butyrate and ethyl butyrate; linear carbonates such as dimethyl carbonate, diethyl carbonate, and ethylmethyl carbonate; linear ethers; and glycol ethers.

When the nonaqueous solvent contains an arbitrary solvent, the content of the arbitrary solvent in the nonaqueous solvent is preferably 0.1 to 50 mass %, more preferably 1 to 30 mass %.

Examples of the supporting electrolyte include quaternary ammonium salts and quaternary phosphonium salts. For example, the quaternary ammonium salts may be a compound having only an aliphatic chain, an alicyclic compound having an aliphatic chain and an aliphatic ring, and a spiro compound having only aliphatic rings. It should be noted that the spiro compound is a compound having a structure in which two rings share one atom of a tetrahedron structure.

A counter ion that constructs the salt is exemplified by PF₆⁻, BF₄⁻, N(CF₃SO₃)₂⁻, and C(CF₃SO₃)₃⁻.

Of those quaternary ammonium salts, examples of the compound having only an aliphatic chain include an triethylmethyl ammonium (TEMA) salt represented by the following formula (1) and a tetraethyl ammonium (TEA) salt represented by the following formula (2) (in the formulae (1) and (2), X⁻ represents a counter ion). Examples of the spiro compound include 5-azoniaspiro[4.4]nonane tetrafluoroborate (spiro-(1,1′)-bipyrrolidinium: SBP-BF₄) represented by the following formula (3), 6-azoniaspiro[5.5]undecane tetrafluoroborate represented by the following formula (4), 3-azoniaspiro[2.6]nonane tetrafluoroborate represented by the following formula (5), formula (6). Further, examples of the quaternary phosphonium salt include 5-phosphonylspiro[4.4]nonane tetrafluoroborate represented by the following formula (7). The supporting electrolyte is preferably a quaternary ammonium salt, more preferably a spiro compound, still more preferably 5-azoniaspiro[4.4]nonane tetrafluoroborate. The spiro compound of the quaternary ammonium salt has a high electric conductivity, and hence can increase a service capacity.

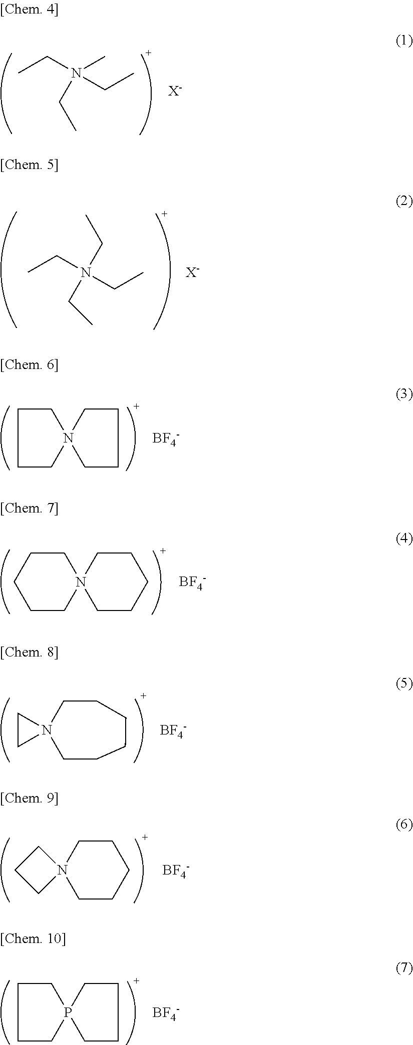

The content of the supporting electrolyte in the electrolytic solution 50 can be determined by taking into consideration of the type of the supporting electrolyte, or the like. For example, when the supporting electrolyte is SBP-BF₄, the content of the supporting electrolyte in the electrolytic solution 50 used in the injection step described later is preferably 1.0 to 3.6 mol/dm³, more preferably 1.5 to 3.6 mol/dm³. If it is less than 1.0 mol/dm³, the electrolytic solution 50 remarkably deteriorates when changed with a voltage of more than 3 V. Then, the service capacity lowers easily within a short period of time. If it exceeds 3.6 mol/dm³, the amount of SBP-BF₄ dissolved in the nonaquaous solvent is saturated. Thus, some disadvantages, such as clogging of nozzles, in the manufacturing process may occur in the injection step described later.

Further, the nonaqueous solvent and the supporting electrolyte evaporate in the preheating step and the sealing step, which are described later. In this case, sulfolane, the linear sulfone, and the arbitrary solvent in the nonaqueous solvent evaporate easily as compared to the supporting electrolyte, and hence the content of the supporting electrolyte increases in the electrolytic solution 50 of the electric double layer capacitor 1 as a final product. Therefore, the content of the supporting electrolyte in the electrolytic solution 50 to be filled in the injection step may be adjusted taking into consideration of the type of the nonaqueous solvent or the like so that the content of the supporting electrolyte in the electrolytic solution 50 of the electric double layer capacitor 1 as a final product is preferably 1.0 to 3.6 mol/dm³, more preferably 1.5 to 3.6 mol/dm³.

Here, the supporting electrolyte is decomposed and reduced when a voltage is applied to the electric double layer capacitor 1. Thus, in the use of the electric double layer capacitor 1 under the application of a high voltage, the supporting electrolyte may be excessive in amount (supersaturation). Alternatively, depending on the heat conditions in the preheating step and the sealing step, which are described later, the supporting electrolyte in the electrolytic solution 50 sealed in the housing container 2 may be in a super-saturation state and then in a temporally deposited state in which the supporting electrolyte cannot dissolved. In this case, the electrolytic solution 50 undergoes a change in solubility of the supporting electrolyte due to the presence of the supporting electrolyte in a supersaturated state and the decomposition product. As a result, the supporting electrolyte is dissolved again and the concentration thereof increases, which provides high service capacity under a low-temperature environment. In this way, the supporting electrolyte corresponding to the decomposed part thereof can be supplemented by bringing the supporting electrolyte into a supersaturation state.

The electrolytic solution 50 may contain an organic fluorine compound. In the sealing step described later, the organic fluorine compound reacts with nickel plating of the lid 10 or the sealing ring 30 to generate nickel fluoride in a passive state on the surface of the lid 10 or the sealing ring 30. Thus, the elution of nickel into the electrolytic solution 50 is suppressed, and degradation of the electrolytic solution 50 by contamination of impurities (nickel) is suppressed. As a result, the electric double layer capacitor 1 can maintain high service capacity for a long period of time.

The organic fluorine compound may be any of organic compounds in which part or all of substituents are replaced with fluorine. Examples of such compound include: an organic compound in which fluorine is introduced into an aromatic hydrocarbon (fluorinated aromatic compound); an organic compound in which fluorine is introduced into a saturated hydrocarbon (fluorinated saturated hydrocarbon); an organic compound in which fluorine is introduced into a linear unsaturated hydrocarbon; an organic compound in which fluorine is introduced into an ester compound, such as a formic acid ester, an acetic acid ester, and a butyric acid ester (fluorinated ester); an organic compound in which fluorine is introduced into an ether compound (fluorinated ether); an organic compound in which fluorine is introduced into a ketone compound (fluorinated ketone); and an organic compound in which fluorine is introduced into any of ethylene carbonate, propylene carbonate, butylene carbonate, and the like (fluorinated carbonate).

Examples of the fluorinated aromatic compound include decafluorobenzophenone (bp: 206° C., melting point (mp): 92 to 94° C.), 1,3-bis(trifluoromethyl)benzene (bp: 116° C., mp: −35° C.), 4,4′-difluorobenzophenone (bp: 170° C. (10 torr), mp: 106 to 109° C.), octafluoronaphthalene (bp: 209° C., mp: 87 to 88° C.), 1-fluoronaphthalene (bp: 215 to 217° C., mp: −13° C.), octafluorotoluene (bp: 104° C., mp: −65.6° C.), allylpentafluorobenzene (bp: 148 to 149° C., mp: −64° C.), 1,2,3,4-tetrafluorobenzene (bp: 95° C., mp: −42° C.), 1,2,3,5-tetrafluorobenzene (bp: 83° C., mp: −48° C.), 1,2,4,5-tetrafluorobenzene (bp: 90° C., mp: 4° C.), 1,2,3-trifluorobenzene (bp: 94 to 95° C.), 1,2,4-trifluorobenzene (bp: 88 to 91° C., mp: −12° C.), 1,3,5-trifluorobenzene (bp: 75 to 76° C., mp: −5.5° C.), 1,2-difluorobenzene (bp: 92° C., mp: −34° C.), 1,3-difluorobenzene (bp: 83° C., mp: −59° C.), 1,4-difluorobenzene (bp: 88 to 89° C., mp: −13° C.), α,α,α-trifluorotoluene (bp: 102° C., mp: −29° C.), fluorobenzene (bp: 85° C., mp: −42° C.), (trifluoromethoxy)benzene (bp: 102° C.), 1-ethynyl-4-fluorobenzene (bp: 55° C. (40 mmHg), mp: 27 to 28° C.), 1,4-bis(difluoromethyl)benzene (bp: 70° C. (2.7 KPa)), 1-acetoxy-4-fluorobenzene (bp: 197° C.), 2,4,6-trimethylfluorobenzene (bp: 163 to 165° C.), 2,6-difluorotoluene (bp: 112° C.), o-fluorotoluene (bp: 114° C., mp: −62° C.), m-fluorotoluene (bp: 115° C., mp: −87° C.), p-fluorotoluene (bp: 116° C., mp: −53° C.), 2,4-difluorotoluene (bp: 114 to 116° C.), 3-fluoro-o-xylene (bp: 148 to 152° C.), 2-fluorostyrene (bp: 29 to 30° C.), 4-fluorostyrene (bp: 67° C. (50 mmHg), mp: −36° C.), and perfluorodecalin (as a mixture of cis and trans, bp: 142° C., mp: −10° C.).

The fluorinated saturated hydrocarbon may be cyclic or linear, and examples thereof include such as 1-fluorohexane (bp: 93° C.), perfluoro-1,3-dimethylcyclohexane (bp: 101 to 102° C., mp: −55° C.), 1-fluoropentane (bp: 62 to 63° C.), 1-fluorononane (bp: 166 to 169° C.), and perfluoro-2-methyl-2-pentene (bp: 53 to 61° C.).

Examples of the compound in which fluorine is introduced into a linear unsaturated hydrocarbon include (perfluorobutyl)ethylene (bp: 58° C.).

Examples of the fluorinated ester include ethyl fluoroacetate (bp: 117° C.), ethyl 4,4,4-trifluoroacetoacetate (bp: 131° C., mp: −39° C.), and methyl 2-fluorophenylacetate.

The fluorinated ether may have an oxygen-centered symmetric or asymmetric structure. Of those, an asymmetric structure is preferred. Examples of the fluorinated ether include 2,2,2-trifluoroethyl methyl ether (bp: 30° C.), 1,1,2,2-tetrafluoroethyl 2,2,3,3-tetrafluoropropyl ether (bp: 92° C.), 1,1,2,2-tetrafluoroethyl 2,2,2-trifluoroethyl ether (bp: 50° C., mp: −94° C.), 1,1,2,2-tetrafluoroethyl ethyl ether (bp: 57.5° C., mp: −90.8° C.), 1,1,2,2-tetrafluoroethyl methyl ether (bp: 36 to 37° C., mp: −107° C.), and perfluoropolyethers represented by F—(CF₂CF₂CF₂O)ₙCF₂CF₃ (provided that n represents a repetition number of (CF₂CF₂CF₂O)). Examples of the fluorinated ether which is commercially available include Novec™7000 (C₃F₇OCH₃), Novec™ 7100 (C₄F₉OCH₃), Novec™ 7200 (C₄F₉OC₂H₅), and Novec™ 7300 (C₂F₅CF(OCH₃)C₃F₇) (all of the perfluoroethers are manufactured by Sumitomo 3M Limited.).

Examples of the perfluoropolyethers which are commercially available include DEMNUM™ S-20 (average molecular weight: 2,700, pour point: −75° C.), DEMNUM™ S-65 (average molecular weight: 4,500, pour point: −65° C.), and DEMNUM™ S-200 (average molecular weight: 8,400, pour point: −53° C.) (all of the perfluoropolyethers are manufactured by DAIKIN INDUSTRIES, LTD.).

Examples of the fluorinated ketone include 1,1,1-trifluoroacetone (bp: 22° C., mp: −78° C.), cyclopropyl 4-fluorophenyl ketone (bp: 119 to 120° C., mp: −15° C.), and cyclobutyl 4-fluorophenyl ketone (bp: 125 to 127° C.).

The boiling point of the organic fluorine compound is preferably less than that of sulfolane (285° C.), more preferably 240° C. or less, still more preferably 150° C. or less. When the boiling point of the organic fluorine compound is less than that of sulfolane, the viscosity of the electrolytic solution 50 can be reduced. Thus, the polarizable electrodes 40 or the separator 46 can be impregnated with the electrolytic solution 50 sufficiently and quickly. Additionally, when the boiling point of the organic fluorine compound is less than that of sulfolane, the organic fluorine compound can be easily vaporized in the preheating step described later. Thus, the use of the organic fluorine compound having a boiling point equal to or less than the above-mentioned upper limit can easily adjust the percentage of a void.

The lower limit of the boiling point of the organic fluorine compound is not particularly limited, and is preferably 30° C. or more, more preferably 60° C. or more, still more preferably 100° C. or more. When the boiling point of the organic fluorine compound is 30° C. or more, the electrolytic solution 50 can be prevented from bumping easily and the remaining amount of the electrolytic solution 50 in the housing container 2 can be prevented from varying in the preheating step, sealing step, and reflow-soldering step, which are described later.

The melting point of the organic fluorine compound is not particularly limited, and is preferably room temperature (25° C.) or less, more preferably −30° C. or less. When the melting point of the organic fluorine compound is room temperature or less, the viscosity of the electrolytic solution 50 can be reduced. Thus, the polarizable electrodes 40 or the separator 46 can be impregnated with the electrolytic solution 50 sufficiently and quickly. In addition, when the melting point of the organic fluorine compound is −30° C. or less, securing of the service capacity under a low-temperature environment is easier.

Of the above-mentioned organic fluorine compounds, preferred are decafluorobenzophenone, 4,4′-difluorobenzophenone, 1-fluoronaphthalene, octafluoronaphthalene, 1,2,4,5-tetrafluorobenzene, 1,2,3-trifluorobenzene, 1-ethynyl-4-fluorobenzene, 2-fluorostyrene, perfluoro-2-methyl-2-pentene, (perfluorobutyl)ethylene, 1,2,3,4-tetrafluorobenzene, 1,2,3,5-tetrafluorobenzene, 1,2,4-trifluorobenzene, 1,3,5-trifluorobenzene, 1,2-difluorobenzene, 1,3-difluorobenzene, 1,4-difluorobenzene, fluorobenzene, (trifluoromethoxy)benzene, 1,4-bis(difluoromethyl)benzene, 4-fluorostyrene, perfluorodecalin (as a mixture of cis and trans), 1-fluorohexane, 1-fluoropentane, 1-fluorononane, 1,3-bis(trifluoromethyl)benzene, octafluorotoluene, allylpentafluorobenzene, α,α,α-trifluorotoluene, 1-acetoxy-4-fluorobenzene, 2,4,6-trimethylfluorobenzene, 2,6-difluorotoluene, o-fluorotoluene, m-fluorotoluene, p-fluorotoluene, 2,4-difluorotoluene, 3-fluoro-o-xylene, perfluoro-1,3-dimethylcyclohexane, ethyl fluoroacetate, and ethyl 4,4,4-trifluoroacetoacetate, more preferred are 1,2,3,4-tetrafluorobenzene, 1,2,3,5-tetrafluorobenzene, 1,2,4-trifluorobenzene, 1,3,5-trifluorobenzene, 1,2-difluorobenzene, 1,3-difluorobenzene, 1,4-difluorobenzene, fluorobenzene, (trifluoromethoxy)benzene, 1,4-bis(difluoromethyl)benzene, 4-fluorostyrene, perfluorodecalin (as a mixture of cis and trans), 1-fluorohexane, 1-fluoropentane, 1-fluorononane, 1,3-bis(trifluoromethyl)benzene, octafluorotoluene, allylpentafluorobenzene, α,α,α-trifluorotoluene, 1-acetoxy-4-fluorobenzene, 2,4,6-trimethylfluorobenzene, 2,6-difluorotoluene, o-fluorotoluene, m-fluorotoluene, p-fluorotoluene, 2,4-difluorotoluene, 3-fluoro-o-xylene, perfluoro-1,3-dimethylcyclohexane, ethyl fluoroacetate, and ethyl 4,4,4-trifluoroacetoacetate, and still more preferred are 1,3-bis(trifluoromethyl)benzene, octafluorotoluene, allylpentafluorobenzene, α,α,α-trifluorotoluene, 1-acetoxy-4-fluorobenzene, 2,4,6-trimethylfluorobenzene, 2,6-difluorotoluene, o-fluorotoluene, m-fluorotoluene, p-fluorotoluene, 2,4-difluorotoluene, 3-fluoro-o-xylene, perfluoro-1,3-dimethylcyclohexane, ethyl fluoroacetate, and ethyl 4,4,4-trifluoroacetoacetate. Any of those organic fluorine compounds can more easily provide both a reduction in viscosity of the electrolytic solution 50 and securing of the service capacity under a low-temperature environment.

The content of the organic fluorine compound in the electrolytic solution 50 to be used in the injection step described later can be determined taking into consideration of the desired property of the electrolytic solution 50, such as viscosity thereof. For example, it is preferably 0.1 to 50 mass %, more preferably 0.1 to 20 mass %. If it is less than 0.1 mass %, the viscosity of the electrolytic solution 50 may be hardly reduced sufficiently and the generation of nickel fluoride may be insufficient. If it exceeds 50 mass %, a reduction in amount of the supporting electrolyte dissolved in the nonaqueous solvent occurs. As a result, the service capacity may be decreased.

Further, the content of the organic fluorine compound in the electrolytic solution 50 of the electric double layer capacitor 1 as a final product, is preferably 10 mass ppm to 30 mass %, more preferably 10 mass ppm to 10 mass %. If it is less than 10 mass ppm, the service capacity under a low-temperature environment may be hardly increased in a sufficient manner. If it exceeds 30 mass %, the concentration of the supporting electrolyte in the electrolytic solution 50 may be decreased. In both cases, the characteristics of the charge and discharge are decreased.

The electrolytic solution 50 may be prepared by, for example, mixing sulfolane, a linear sulfone, and optionally an arbitrary solvent together to obtain a nonaqueous solvent, adding a supporting electrolyte to the nonaqueous solvent, and dissolving them by stirring. Alternatively, if required, the organic fluorine compound and the supporting electrolyte may be simultaneously added to the nonaqueous solvent and then mixed together.

The anode side electrode 42 may be one prepared by, for example, carrying out pressure-rolling or press-molding active carbon powders together with a binder. Here, the active carbon powders are obtained by subjecting an organic material to activation treatment using, for example, steam or an alkali alone or in combination. The organic material may be, for example, saw dusts, coconut husks, pitch, coke, or a phenol resin. Alternatively, the anode side electrode 42 may be one prepared by subjecting phenol-based, rayon-based, acryl-based, pitch-based fibers, or the like to non-solubilization and carbonization-activation treatment to obtain active carbon or active carbon fibers, followed by forming the active carbon or active carbon fibers into a felt, fiber, or paper, or sintered body form.

The density of the anode side electrode 42 is not particularly limited, and is preferably 0.1 to 0.9 g/cm³, more preferably 0.40 to 0.75 g/cm³. If it is less than 0.1 g/cm³, the energy density of the anode side electrode 42 lowers. Simultaneously, the distance between the electrode particles may spread and the electrical resistance thereof may increase when the anode side electrode 42 expands by the impregnation with the electrolytic solution 50. If it exceeds 0.9 g/cm³, a large amount of pressure is required when the anode side electrode 42 is fabricated. In this case, further, the amount of the electrolytic solution 50 with which the anode side electrode 42 is impregnated is remarkably decreased.

Active carbons, which are active substances used for the anode side electrode 42, may be provided with various different pore distributions and surface conditions when prepared using different starting materials, carbonization treatments, or activation conditions. Of the active carbons having such various surface conditions and pore distributions, the specific surface area of the active carbon used as an active material for the anode side electrode 42 is preferably 1,000 m²/g or more, more preferably 1,700 m²/g or more, still more preferably 2,400 m²/g. If it is 1,000 m²/g or more, a sufficient electrostatic capacity can be obtained.

The pore volume of the active carbon is preferably 0.4 cm³/g or more, more preferably 0.7 cm³/g or more. If the pore volume is 0.4 cm³/g or more, a sufficient electrostatic capacity can be obtained.

Further, with regard to the pores of the active carbon, a value represented by the ratio of pores each having a pore radius of less than 1 nm in all the pores (ratio of fine pores), i.e., “(number of pores each having a pore radius of less than 1 nm)/(number of all pores),” is preferably 75% or less, more preferably 50% or less, still more preferably 30% or less. If it is 75% or less, a sufficient electrostatic capacity can be obtained.

Further, with regard to the pores of the active carbon, a value represented by the ratio of pores each having a pore radius of 1 to 3 nm in all the pores (ratio of medium-sized pores), i.e., “(number of pores each having a pore radius of 1 to 3 nm)/(number of all pores),” is preferably 20% or more, more preferably 50% or more, still more preferably 70% or more. If it is 20% or more, a sufficient electrostatic capacity can be obtained. If it is 70% or more, the active carbon may be combined with the electrolytic solution 50 containing sulfolane. In this case, a further improvement in anti-deterioration performance against a continuous application of a high voltage of 3 V or more can be obtained.

The binder may be any of conventionally known substances. Examples thereof include polytetrafluoroethylene (PTFE), polyvinylidene fluoride (PVDF), styrene-butadiene rubber (SBR), polyacrylic acid-based polymers, and carboxymethyl cellulose. Of those, PTFE is most preferred. The content of the binder in the anode side electrode 42 is, for example, preferably 2 to 14 mass %, more preferably 4 to 12 mass % from the viewpoint of an improvement in durability and an improvement in handling property in production.

A conductivity imparting agent can be added to the anode side electrode 42 if required. Examples of the conductivity imparting agent include amorphous carbons such as carbon blacks, such as furnace black, ketjen black, and acetylene black, crystalline carbonaceous materials, such as a carbon fiber (CF), a carbon nanohorn (CNH), a carbon nanotube (CNT), and graphite power, and powders of metals each having high corrosion resistance, such as Ni and Ti. Of those, carbon black is preferred, and furnace black is more preferred.

The cathode side electrode 44 may have the same configuration as that of the anode side electrode 42, for example.

The anode side electrode 42 and the cathode side electrode 44 may be identical to or different from each other, and may be determined taking into consideration of, for example, the type of the supporting electrolyte. Here, when the applied voltage during charging the electric double layer capacitor 1, cations in the supporting electrolyte are adsorbed on the anode side electrode 42 and decomposed on the surface of the electrode. Thus, the concentration of the cations in the electrolytic solution 50 decreases. The service capacity of the electric double layer capacitor 1 decreases as the concentration of the supporting electrolyte decreases. Similarly, anions in the supporting electrolyte are adsorbed on the cathode side electrode 44 and decomposed on the surface of the electrode. Thus, the concentration of the cations in the electrolytic solution 50 decreases. The service capacity of the electric double layer capacitor 1 decreases as the concentration of the supporting electrolyte decreases. In the electric double layer capacitor 1, for example, cations are remarkably decomposed when a quaternary ammonium salt or the like is used as the supporting electrolyte. Thus, a voltage to be applied to the anode side electrode 42 decreases, and there is a need of operation in a potential window. Therefore, a surface area ratio represented by the ratio [surface area of anode side electrode 42]/[surface area of cathode side electrode 44] is preferably in the range of 1.0 to 1.2, more preferably more than 1.05 and less than 1.15.

If the surface area ratio is less than 1.0, it is difficult to lower the voltage to be applied to the anode side electrode 42. In addition, if the surface area ratio exceeds 1.05, the density of ion species adsorbed on the surface of the anode side electrode 42 can be reduced to 5% or less. Starting from the state in which the cathode and anode are at the same potential, the potential applied to the anode side electrode 42 can be lowered by about 5% as compared to the potential applied to the cathode side electrode 44. For this reason, the voltage applied to the anode side electrode 42 can be reduced by about 5%, and the decomposition of cations in the supporting electrolyte can be suppressed.

Further, if the surface area ratio exceeds 1.2, the voltage of the cathode side electrode 44 is increased as compared to the voltage of the anode side electrode 42. The decomposition of the nonaqueous solvent or the like as well as the supporting electrolyte tends to occur. Thus, the electric double layer capacitor 1 deteriorates easily. In addition, if the surface area ratio is less than 1.15, the balance between the anode side electrode 42 and the cathode side electrode 44 is increased. Thus, the electric double layer capacitor 1 can be prevented from being deteriorated.

The surface area ratio is adjusted to more than 1.0 by making the volume of the anode side electrode 42 higher than that of the cathode side electrode 44 or making the specific surface area of the raw material of the anode side electrode 42 higher than that of the cathode side electrode 44.

The thickness of the separator 46 is not particularly limited. However, for example, the thickness of an intercalated portion 46a interposed between the anode side electrode 42 and the cathode side electrode 44 is preferably 30 to 100 μm, more preferably 40 to 70 μm. If the thickness of the intercalated portion 46a is less than 30 μm, a short circuit may occur as a result of an impaired function of separating the anode side electrode 42 and the cathode side electrode 44. If the thickness of the intercalated portion 46a exceeds 100 μm, the resistance between the electrodes increases. Thus, the service capacity may decrease.

The percentage of a void in the intercalated portion 46a (percentage of a void in the intercalated portion) is preferably 40 to 94 vol %, more preferably 60 to 90 vol %. If the percentage of a void in the intercalated portion is in the above-mentioned range, the amount of the electrolytic solution 50 in the intercalated portion 46a becomes sufficient. A further decrease in surface capacity hardly occurs and the intercalated portion 46a is appropriately filled with the electrolytic solution 50 through a capillary phenomenon. Therefore, the service capacity can be easily retained for a long period of time. It should be noted that the percentage of a void in the intercalated portion is represented by the following equation (ii).

Percentage of void in intercalated portion(vol %)=[(volume of void in intercalated portion)/(volume of intercalated portion)]×100 (ii)

The separator 46 is provided with a periphery 46b which is a portion extending outside the intercalated portion 46a. The thickness of the periphery 46b may be equal to or different from the thickness of the intercalated portion 46a. However, from the viewpoint of efficiently supplying the electrolytic solution 50 into the intercalated portion 46a by increasing the contact area with the electrolytic solution 50, it is preferred to make the periphery 46b thicker than the intercalated portion 46a.

The percentage of a void in the periphery 46b (percentage of a void in the periphery) may be equal to or different from the percentage of a void in the intercalated portion. However, in the viewpoint of retaining the service capacity for a long period of time, a separator crude density, which is represented by the ratio [percentage of a void in the periphery]/[percentage of a void in the intercalated portion], is preferably more than 1, more preferably 1.5 or more, more preferably 2.2 or more. As the separator crude density becomes higher, the electrolytic solution 50 can be more efficiently supplied to the intercalated portion 46a. Thus, the service capacity can be easily retained for a long period of time. The upper limit of the separator crude density is not particularly limited and is preferably 4 or less, more preferably 3 or less, still more preferably 2.5 or less. If the separator crude density exceeds the above-mentioned upper limit, the percentage of a void in the intercalated portion 46a is too small. Thus, the amount of the electrolytic solution 50 in the intercalated portion 46a becomes insufficient and may cause a decrease in service capacity. In addition, if the separator crude density exceeds the above-mentioned upper limit, the thickness of the intercalated portion 46a becomes too small. Thus, a short circuit may easily occur due to the breakdown or the like of the separator 46. Further, if the separator crude density exceeds the above-mentioned upper limit, the separator 46 may cause a repulsive force under compression, with the result that sealing failure may occur when the container is sealed with the lid 10. It should be noted that the percentage of a void in the periphery is represented by the following equation (iii).

Percentage of void in periphery (vol %)=[(volume of void in periphery)/(volume of periphery)]×100 (iii)

The separator 46 may be one which is conventionally used in an electric double layer capacitor. A material of the separator 46 is, for example, a microporous film of polytetrafluoroethylene (PTFE), a laminate of glass fiber made of, for example, borosilicate glass, alkali glass, quartz glass, lead glass, soda lime silica glass, or alkali-free glass (glass fiber laminate), and a nonwoven fabric made of a resin, such as polyphenylene sulfide, polyamide, or polyimide. Of those, a glass fiber laminate is preferred, a borosilicate glass, alkali glass, or quartz glass fiber laminate is more preferred, and a borosilicate glass fiber laminate is still more preferred. The glass fiber laminate is excellent in mechanical strength while having a high ion permeability. Thus, the internal resistance can be reduced to improve the service capacity.

The glass fiber laminate is such that glass fibers are bonded with a binder and unified as a whole, while forming voids. The glass fiber laminate is prepared by forming a mixture of fibers made of glass (glass fibers) with a binder into any desired shape and subjecting the resultant to a heat treatment at a temperature of 25 to 250° C. A preferred heating temperature is 120° C. or less when the binder used is of a water-soluble type. A temperature of higher than 120° C. is unfavorable because the binder is denatured and exhibits hydrophobicity. However, this temperature limitation is not applicable to the case where the binder is subjected to complete carbonization in the separator-heating treatment described below.

The separator 46 preferably contains impurities as low as possible. Particularly preferably, the separator 46 is free of metals such as cadmium, manganese, zinc, copper, nickel, chromium, and iron. The contents of the metals in the separator 46 are preferably less than 1 μg/g of cadmium, less than 0.5 μg/g of manganese, less than 5 μg/g of zinc, less than 4 μg/g of copper, less than 1 μg/g of nickel, less than 1 μg/g of chromium, and less than 25 μg/g of iron, respectively.

Each glass fiber that constructs the glass fiber laminate is preferably one having a fiber diameter of 10 μm or less, more preferably one having a fiber diameter of 1 μm or less. If the fiber diameter is 10 μm or less, the sizes of individual voids formed in the separator 46 when fibers are laminated can be reduced. The impregnation of the electrolytic solution 50 into the separator 46 by capillarity becomes more prompt. In addition, an increase in liquid retaining power of the separator 46 leads to a decrease in inter-electrode ionic conductance. Thus, the inner resistance of the electric double layer capacitor 1 can be reduced more greatly.

In addition, the glass fibers that construct the glass fiber laminate may include a mixture of glass fibers each having a fiber diameter of more than 1 μm and 10 μm or less and glass fibers each having a fiber diameter of 1 μm or less. In this case, the glass fibers may preferably include 80 mass % or more of glass fibers each having a fiber diameter of 1 μm. When the glass fibers include 80 mass % or more of glass fibers each having a fiber diameter of 1 μm or less, the electrolytic solution 50 can be further facilitated to be impregnated into the separator 46, leading to a further decrease in resistance between the electrodes.

The binder is not particularly limited as long as it is water-soluble. Examples of the binder include carboxymethyl cellulose (CMC), sodium polyacrylate (PAS), polyacrylic acid (PAA), polyvinyl alcohol (PVA), and a modified polyacrylic resin. When polyacrylic acid is used as the binder, cross-linked acrylic acid is preferably used. It should be noted that the binder has hydrophilic property but may exert water-repellent property after the heat treatment.

The lid 10 is a plate made of a conductive metal such as Kovar (iron-nickel-cobalt alloy) or a nickel-iron alloy containing about 50 mass % of nickel and coated with nickel plating.

The seal ring 30 may be made of Kovar or the like with nickel plating, for example.

The lid 10 and the seal ring 30 are preferably made of materials having the same thermal expansion coefficient to prevent a sealed portion from becoming fragile due to an expansion rate at the time of joining the lid and the seal ring and a stress at the time of shrinkage caused by cooling after joining the lid and the seal ring. Likewise, the seal ring 30 and the container body 20 are selected from materials having proximate thermal expansion coefficients to prevent the container body 2 from being broken by the remaining stress with heat. Here, for example, alumina (Al₂O₃) used as a principal component of the housing container 2 has a representative value (400° C.) of a linear expansion coefficient of 7.1×10⁻⁶ K⁻¹ and Kovar used as a principal component of each of the lid 10 and the seal ring 30 has a representative value of a linear expansion coefficient of 4.9×10⁻⁶ K⁻¹.

Examples of the soldering material 32 include conventionally known soldering materials, such as gold solder, silver solder, and silver copper solder.

Examples of the substrate 22 include heat-resistant materials having insulating property, such as ceramic, glass, plastic, and alumina.

The side wall portion 24 is made of the same material as that of the substrate 22. The side wall portion 24 is obtained by sintering a green sheet, for example.

The intermediate layer 26 is made of the same material as that of the substrate 22. The intermediate layer 26 is, for example, made of a green sheet just as in the case with the side wall portion 24. The intermediate layer may be formed by providing the second metal layer 72 on the substrate 22, applying a green sheet of, for example, ceramic, glass, or alumina to the second metal layer 72 so as to cover the second metal layer 72, and sintering the resultant.

The protective layer 27 is made of a conductive metal, such as aluminum, tungsten, gold, or silver or a conductive filler, such as a carbon-containing conductive resin, for example. Of those, aluminum and a conductive resin are preferred. The protective layer 27 can be formed such that any number of conductive metals, conductive resins, or the like are formed and sintered on any place when the intermediate layer 26 is formed.

The first external terminal 60 is a plate or thin film made of a conductive metal, such as nickel or gold, and formed by conductor printing and sintering on the container body 20. On the surface of the first external terminal 60, a weldable layer of nickel, gold, solder, or the like is preferably formed so as to be weldable on the substrate. This weldable layer can be formed by a gas phase process, such as plating or vapor deposition.

The configuration of the second external terminal 70 is the same as that of the first external terminal 60.

The first metal layer 62 is a plate or thin film made of a conductive metal, such as tungsten, nickel, gold, or silver and is formed by, for example, printing the metal on a green sheet and sintering the resultant. Of those, the first metal layer 62 is made of tungsten. The configuration of the second metal layer 72 is the same as that of the first metal layer 62.

Next, a manufacturing method for the electric double layer capacitor 1 is described.

First, the container body 20 provided with the intermediate layer 26, the protective layer 27, the first external terminal 60, the first metal layer 62, the second external terminal 70, and the second metal layer 72 is prepared. The seal ring 30 is joined to the periphery of the opening of the container body 20, i.e., the upper end surface 23 of the side wall portion 24 by the soldering material 32. Next, nickel plating is performed to cover the seal ring 30, the soldering material 32, and the upper end surface 23. The nickel plating may be performed by, for example, electrolytic nickel plating or electroless nickel plating.

The cathode side electrode 44 is attached on the inner bottom surface of the container body 20 through the cathode collector 45. The separator 46 is mounted on the attached cathode side electrode 44. Then, any amount of the electrolytic solution 50 is injected into the container body 20 (injection step). The amount of the electrolytic solution 50 injected may be determined taking into consideration of the type of a nonaqueous solvent, the percentage of a void in the electric double layer capacitor 1, and the like.

Here, when a glass fiber laminate containing a binder is used as the separator 46, the separator 46 may be heated before the injection of the electrolytic solution 50 (separator-heating treatment). By heating the separator 46, the binder is carbonized. As a result, the binder decreases in amount or disappears. As the binder decreases or disappears, the percentage of a void in the intercalated portion and the percentage of a void in the periphery of the separator 46 increase. Thus, the electrolytic solution 50 can be quickly impregnated in a large amount into the separator 46. In the separator-heating treatment, the heating temperature is preferably 250 to 350° C. If the temperature is less than 250° C., a sufficient reduction in amount of the binder may be hardly attained. If it exceeds 350° C., the polarizable electrodes 40 prepared using active carbon may lose their mechanical strength and become difficult to keep their shapes.

The anode side electrode 42 is attached on one surface of the lid 10 through the anode collector 43 and the lid 10 is mounted on the seal ring 30 to make the anode side electrode 42 abut the separator 46. Alternatively, the anode side electrode 42 is mounted so as to abut the separator 46. Then, the lid 10, on which the anode collector 43 is previously formed, is mounted on the seal ring 30 (electrode-arrangement step).

Subsequently, the lid 10 and the seal ring 30 are partially melted and welded to make an unsealed body. A method of partially welding the lid 10 and the seal ring 30 may be, for example, a method of partially welding the nickel plating of the lid 10 and the nickel plating covering the seal ring 30 by resistance welding, laser welding, hot welding, or the like. Of those, resistance welding is preferred. The term “partially welding” means that the lid 10 and the seal ring 30 are welded by spot welding or the like in which welding portions are placed at intervals.

The unsealed body obtained by partially welding the lid 10 and the seal ring 30 is heated at 200° C. or more and less than 900° C. (preheating step). In this preheating step, impurities, such as moisture, can be removed from the electrolytic solution 50, or part of a nonaqueous solvent and part of an organic fluorine compound can be evaporated to increase the concentration of the supporting electrolyte in the electrolytic solution 50. In addition, the viscosity of the electrolytic solution 50 is reduced by heating. Thus, the electrolytic solution 50 can be sufficiently impregnated into the polarizable electrodes 40 or the separator 46. A method of heating in the preheating step is not particularly limited. Examples thereof include a method of heating including application of power to the lid 10, and a method of heating with infrared rays, laser radiation, or warm air. Of those, a method including application of power to the lid 10 is preferred. By applying power to the lid 10, the temperature of the electrolytic solution 50 increases within in a short period of time. Thus, the impurities in the electrolytic solution 50 can be efficiently removed. In addition, the application of power to the lid 10 can also serve as partial welding between the lid 10 and the seal ring 30 as described above. Thus, an improvement in production efficiency of the electric double layer capacity 1 can be attained.

The heating time can be determined taking into consideration of the type of the nonaqueous solvent, the heating method, or the like. Preferably, for example, the heating time may be 1 msec or more. In this case, the electrolytic solution 50 contains sulfolane having a high boiling point and hence is prevented from easily bumping. Thus, the remaining amount of the electrolytic solution 50 in the housing container 2 becomes constant. In addition, in the preheating step, further, removal of impurities each having a low boiling point leads to protection of the electric double layer capacitor 1 from being damaged by vaporization of impurities each having a low boiling point in the sealing step and the reflow soldering as described later.

The lid 10 and the seal ring 30 in the unsealed body are welded together to seal the inside of the housing container 2 by the lid 10 and the container body 20 (sealing step). A method of welding the lid 10 and the seal ring 30 is not particularly limited. Examples thereof include seam welding with resistance welding. In the seam welding, the nickel plating of the lid 10 and the nickel plating covering the seal ring 30 are welded together. In this case, if the electrolytic solution 50 contains an organic fluorine compound, a coating film of nickel fluoride is formed on the surface of the lid 10 or the seal ring 30.

In the sealing step, the electrolytic solution 50 is exposed to the melting point (800 to 1,455° C.) of the nickel plating. However, the electrolytic solution contains sulfolane having a high boiling point, and hence does not easily cause bumping. Thus, the remaining amount of the electrolytic solution 50 in the housing container 2 is kept constant. In addition, the bumping of the electrolytic solution 50 does not easily occur, and hence the housing container 2 can be prevented from being damaged in the sealing step. Further, when the electrolytic solution 50 contains an organic fluorine compound, the electrolytic solution can be quickly impregnated into the polarizable electrodes 40 and the separator 46.

Thus, the electric double layer capacitor 1 with a constant amount of the electrolytic solution 50 can be obtained.

The electrolytic solution according to this embodiment contains a linear sulfone in the nonaqueous solvent, and hence is in a liquid form even if it contains solid sulfone at normal temperature. Thus, the separator and the polarizable electrodes can be impregnated with the electrolytic solution. Thus, the functions of the electric double layer capacitor can be exerted.

The electric double layer capacitor according to this embodiment is provided with the electrolytic solution containing a linear sulfone in the nonaqueous solvent, and hence the electrolytic solution hardly causes bumping in the preheating step or sealing step. Thus, the remaining amount of the electrolytic solution becomes stable, and the quality of the electric double layer capacitor becomes stable. In addition, at the time of reflow soldering, the leakage of the electrolytic solution and the damage on the housing container due to sudden vaporization of the electrolytic solution can be prevented. Further, the amount of the electrolytic solution can be increased. Thus, the electric double layer capacitor can be used over a long period of time under the condition of application of a high voltage of 3.0 V or more.

According to the manufacturing method for the electric double layer capacitor according to this embodiment, the electrolytic solution containing sulfolane is used. Thus, the electrolytic solution can be prevented from being leaked easily when the lid and the container body are welded, and the electric double layer capacitor having stable quality can be obtained. Further, the preheating step may be included in the method. In this case, impurities, such as moisture, which cause degradation of the electrolytic solution can be removed. In addition, an excess amount of the nonaqueous solvent can be evaporated to increase the amount of the supporting electrolyte. Thus, even under the condition of applying a high voltage to the electric double layer capacitor, the electric double layer capacitor can be used for a long period of time.

The present invention is not limited to the above-mentioned embodiment.

Although the electric double layer capacitor according to the above-mentioned embodiment is of a chip type. However, the present invention is not limited to this type. Alternatively, it may be of a button type.

However, the effects of the present invention may be remarkably exerted in the electric double layer capacitor of a chip type in which the lid and the container body are welded at high temperature while keeping high air tightness.

In the above-mentioned embodiment, the electric double layer capacitor is of a chip type including the container body having a square tube shape with a closed bottom end and the lid having a flat plate shape, in which the external terminal is mounted on the container body. However, the present invention is not limited to such chip type. For example, the electric double layer capacitor of a chip type as shown in FIG. 2 may also be used.

An electric double layer capacitor 100 shown in FIG. 2 includes a pair of polarizable electrodes 40, i.e., an anode side electrode 42 and a cathode side electrode 44, which are arranged opposite to each other via a separator 46, and an electrolytic solution 50 in a housing container 102. In addition, the polarizable electrodes 40 and the separator 46 are impregnated with the electrolytic solution 50 in the housing container 102.

The housing container 102 includes a container body 110 having a square tube shape with a closed bottom, a lid 120 having a flat plate shape for sealing the opening of the container body 110, and a seal ring 130 placed on the periphery of the opening of the container body 110. The container body 110 is sealed with the lid 120 through the seal ring 130.

The container body 110 includes a top wall portion 112 having a substantially rectangular shape in a planer view, a side wall portion 114 having a rectangular tube shape, which extends downward from the periphery of the top wall portion 112, and a flange portion 116, which is formed on the lower end of the side wall portion 114 and extends in the direction extending away from the axial line of the side wall portion 114.

The lid 120 has a two-layer structure formed of an upper layer 122 and a lower layer 124. On almost the center of the surface of the upper layer 122, a first conductor portion 145 having a substantially rectangular shape in a planer view is formed. In the vicinity of the periphery of the upper layer 122, a second conductor portion 132 having a hollow square shape is formed. A first external terminal 160 and a second external terminal 170 are formed on the lower surface 124 from the lateral side to the bottom. A lead-out conductor portion 172 is formed between the upper layer 122 and the lower layer 124 and extends from almost the center of the lid 120 to the periphery thereof. The first external terminal 160 is connected to the second conductor portion 132. The second external terminal 170 is connected to a lead-out conductor portion 172. The lead-out conductor portion 172 is connected to the first conductor portion 145 through a conductor portion 174 passing through the upper layer 122.

The material of the container body 110 is the same as the material of the lid 10.

The material of the substrate 120 is the same as the material of the substrate 22.

The material of the seal ring 130 is the same as the material of the seal ring 30.

The configuration of the first external terminal 160 is the same as the configuration of the first external terminal 60, and the configuration of the second external terminal 170 is the same as the configuration of the second external terminal 70.

The first conductor portion 145 is the same as that of the cathode collector 45, and the second conductor portion 132 is the same as that of the first metal layer 62.

The lead-out conductor portion 172 is the same as that of the first metal layer 62.

Examples of the electric double layer capacitor of a chip type device like the electric double layer capacitor 100 include an electrochemical device described in Japanese Patent Application Laid-open No. 2010-141026.

In the above-mentioned embodiment, the second metal layer is formed between the intermediate layer and the substrate. However, the present invention is not limited thereto. The second metal layer may be formed on the intermediate layer. However, when the electrolytic solution directly contacts the second metal layer, a short circuit may occur. Hence, for example, the second metal layer may be preferably placed between the intermediate layer and the substrate so as to prevent the contact with the electrolytic solution.

In the above-mentioned embodiment, the preheating step is provided. However, the present invention is not limited thereto, and no preheating step may be provided. From the viewpoint of removing impurities or the like from the electrolytic solution and retaining a high service capacity for a long period of time, it is preferred to provide the preheating step.

In the above-mentioned embodiment, in the electrode arrangement step, the lid and the seal ring are partially welded together. However, the present invention is not limited thereto, and the lid may be simply placed on the sealing.

In the above-mentioned embodiment, the sealing of the lid and the container body is performed by welding the nickel plating of the lid and the nickel plating of the seal ring together. However, the present invention is not limited thereto, and for example, the lid and the seal ring may be joined with a soldering material.

### EXAMPLES

Hereinafter, the present invention is described by way of examples. However, the present invention is not limited to these examples.

### Example 1-1

An electrolytic solution was prepared by mixing sulfolane (in the table, represented by SL) and dimethyl sulfone (in the table, represented by DMS) at a ratio of SL:DMS=8:2 (mass ratio) to prepare a nonaqueous solvent, and dissolving the SBP-BF₄ as an electrolytic electrolyte in the nonaqueous solvent so as to have a concentration of 1.5 mol/dm³.

By using the resulting electrolytic solution, an electric double layer capacitor similar to that shown in FIG. 1 was prepared as described below.

Commercial active carbon (specific surface area: 1,900 m²/g, pore volume: 0.85 cm³/g, fine pore ratio: 4%, medium-sized pore ratio: 95%, and number average pore size: 12 μm (measured by a laser mode)) was extended into a sheet of 0.25 mm±0.05 mm in thickness by applying pressure and then cut into pieces each having a size of 1.7 mm×1.0 mm. The resulting pieces are used as a cathode side electrode and an anode side electrode. The anode side electrode was attached to a lid, which was prepared by subjecting a Kovar flat plate to electrolytic nickel plating, by a conductive adhesive. A Kovar seal ring was joined on the periphery of the opening of a container body by silver solder, the container body including a bottom wall portion formed of a ceramic substrate and a ceramic intermediate layer and a ceramic side wall portion. The cathode side electrode was attached on the inner bottom surface of the container body by a conductive adhesive. Then, a microporous sheet (2.25 mm×1.72 mm) made of polytetrafluoroethylene was mounted as a separator on the cathode side electrode. 2 μL of the electrolytic solution were poured onto the cathode side electrode in the container body, and the lid was mounted on the seal ring so that the anode side electrode abutted the separator. Next, the lid and the seal ring were partially welded by spot welding to form an unsealed body. In this case, the lid was heated at 250° C. for 5 msec (preheating step).

Then, the housing container was sealed with seam welding of the resistance welding method. Consequently, an electric double layer capacitor was obtained. It should be noted that the resulting electric double layer capacitor had a percentage of a void of 25 vol % and a surface area ratio of 1.0.

Six electric double layer capacitors thus obtained were applied with a voltage of 3.3 V for 2 hours at an ambient temperature of 24° C. Subsequently, at an ambient temperature of 24° C., the electric double layer capacitor was discharged at a constant current of 5 μA (discharge current) until the voltage reached 2.0 V. Then, the service capacity was calculated by the following equation (I) and the average value was defined as an initial capacity.

Service capacity(μAh)=discharge current(5 μA)×discharge time(h) (I)

Further, six electric double layer capacitors thus obtained were applied with a voltage of 3.3 V for 2 hours at an ambient temperature of 24° C. Subsequently, at an ambient temperature of −20° C., the electric double layer capacitor was discharged at a constant current of 5 μA (discharge current) until the voltage reached 2.0 V. Then, the service capacity was calculated by the above-mentioned equation (I) and the average value was defined as a low-temperature capacity.

From the obtained initial capacity and low-temperature capacity, a low-temperature capacity retention rate was calculated.

Low-temperature capacity retention rate(%)=low-temperature capacity/initial capacity×100 (II)

### Example 1-2

An electric double layer capacitor was obtained in the same manner as in that of Example 1-1, except that the nonaqueous solvent used was sulfolane:ethylmethyl sulfone (EMS)=8:2 (mass ratio). Then, the low-temperature capacity retention rate was obtained.

### Comparative Example 1

An electric double layer capacitor was obtained in the same manner as in that of Example 1-1, except that the nonaqueous solvent used was sulfolane:methyl propionate (MP)=8:2 (mass ratio). Then, the low-temperature capacity retention rate was obtained.

TABLE 1

| | | | | | Comparative |
|---|---|---|---|---|---|
| | | | Example | | Example |
| | | | 1-1 | 1-2 | 1 |
| Nonaqueous | SL | (mass part) | 8 | 8 | 8 |
| solvent | DMS | (mass part) | 2 | — | — |
| | EMS | (mass part) | — | 2 | — |
| | MP | (mass part) | — | — | 2 |

| | | | | |
|---|---|---|---|---|
| Low-temperature | (%) | 80.6 | 81.3 | 54.3 |
| capacity retention rate | | | | |

As shown in Table 1, both of the low-temperature capacity retention rates of Examples 1-1 and 1-2 according to the present invention were 80% or more. On the other hand, in Comparative Example 1 in which methyl propionate was used instead of a linear sulfone, the lower-temperature capacity retention rate was 54.3%.

From those results, it was found that the electric double layer capacitor according to the present invention was able to exert sufficient functions in a stable manner at an ambient temperature of −20° C.

### Example 2-1

An electric double layer capacitor was obtained in the same manner as in Example 1-2, except that the concentration of SBP-BF₄ was 1.0 mol/dm³. Ten electric double layer capacitors thus obtained were applied with a voltage of 3.3 V at an ambient temperature of 70° C. and then stored at 60° C. for 20 days. Subsequently, at an ambient temperature of 24° C., the electric double layer capacitor after the storage was discharged at a constant current of 5μA (discharge current) until the voltage reached 2.0 V. Then, the service capacity was calculated and the average value was defined as a high-temperature capacity. The high-temperature capacity thus obtained and the initial capacity obtained separately were substituted into the following equation (III) to calculate a high-temperature capacity retention rate.

High-temperature capacity retention rate(%)=high-temperature capacity/initial capacity×100 (III)

### Example 2-2

An electric double layer capacitor was obtained in the same manner as in Example 2-1, except that the concentration of SBP-BF₄ was 1.5 mol/dm³. Then, the high-temperature capacity retention rate was calculated.

### Example 2-3

An electric double layer capacitor was obtained in the same manner as in Example 2-1, except that the concentration of SBP-BF₄ was 3.6 mol/dm³. Then, the high-temperature capacity retention rate was calculated.

TABLE 2

| | | Example | | |
|---|---|---|---|---|
| | | 2-1 | 2-2 | 2-3 |
| SBP-BF4 concentration | (mol/dm³) | 1.0 | 1.5 | 3.6 |
| High-temperature capacity | (%) | 80.4 | 85.7 | 90.2 |
| retention rate | | | | |

As shown in Table 2, any of the capacity retention rates of Examples 2-1 to 2-3 according to the present invention was more than 80%. As the concentration of the supporting electrolyte increased, the high-temperature capacity retention rate increased.

### Examples 3-1 to 3-10

Ten electric double layer capacitors for each example were manufactured in the same manner as in Example 2-1, except that the preheating step was performed under the temperature and time shown in Table 3. Then, the presence or absence of damage was determined. In addition, the damage-free electric double layer capacitor was used in calculation of a high-temperature capacity retention rate.

### Comparative Example 2

Ten electric double layer capacitors were manufactured in the same manner as in Example 3-2, except that the nonaqueous solvent was propylene carbonate (PC):dimethyl carbonate (DMC)=8:2 (mass ratio). Then, the presence or absence of damage was determined. In addition, the damage-free electric double layer capacitor was used in calculation of a high-temperature capacity retention rate.

TABLE 3

| | | | | | | High- |
|---|---|---|---|---|---|---|
| | | | | | | temperature |
| | | Preheating step | | | | capacity |
| | | Temperature | Time | Electrolytic | Damage | retention rate |
| | | (° C.) | (msec) | solution | (capacitor(s)) | (%) |
| Example | 3-1 | 200 | 1 | SL-EMS | 0 | 70 |
| | 3-2 | 200 | 10 | SL-EMS | 0 | 85 |
| | 3-3 | 200 | 20 | SL-EMS | 0 | 80 |
| | 3-4 | 300 | 1 | SL-EMS | 0 | 75 |
| | 3-5 | 300 | 10 | SL-EMS | 0 | 60 |
| | 3-6 | 300 | 20 | SL-EMS | 0 | 50 |
| | 3-7 | 900 | 1 | SL-EMS | 0 | 70 |
| | 3-8 | 900 | 10 | SL-EMS | 1 | 50 |
| | 3-9 | 900 | 20 | SL-EMS | 2 | 30 |
| | 3-10 | ND | ND | SL-EMS | 2 | 50 |

| | | | | | |
|---|---|---|---|---|---|
| Comparative | 200 | 10 | PC-DMC | 0 | 10 |
| Example 2 | | | | | |

As shown in Table 3, in any of Examples 3-1 to 3-10 according to the present invention, the number of the damaged electric double layer capacitors was 2 or less. In addition, the high-temperature capacity retention rate was 30% or more.

In addition, the high-temperature capacity retention rate was relatively high and the number of the damaged electric double layer capacitors was small in Examples 3-1 to 3-6 in which the preheating step with a heating temperature of 200° C. or 300° C. was provided as compared to Examples 3-10 in which the preheating step was not provided.

Meanwhile, in Comparative Example 2 in which the nonaqueous solvent was PC-DMC, a large amount of the nonaqueous solvent was evaporated in the preheating step even though no damage was detected. Thus, the high-temperature capacity retention rate was extremely low as 10%.

### Examples 4-1 to 4-5

Ten electric double layer capacitors for each example were manufactured in the same manner as in Example 2-1, except that an electrolytic solution was injected at the percentage of a void shown in Table 4. Then, the presence or absence of damage was determined. In addition, the damage-free electric double layer capacitor was used in calculation of a high-temperature capacity retention rate.

### Comparative Example 3

Ten electric double layer capacitors for each example were manufactured in the same manner as in Example 4-1, except that a nonaqueous solvent was PC:DMS=8:2 (mass ratio). Then, the presence or absence of damage was determined. In addition, the damage-free electric double layer capacitor was used in calculation of a high-temperature capacity retention rate.

TABLE 4

| | | | | High-temperature | |
|---|---|---|---|---|---|
| | | Percentage | Electro- | capacity | |
| | | of void | lytic | retention | Damage |
| | | (vol %) | solution | rate (%) | (capacitor(s)) |
| Example | 4-1 | 10 | SL-EMS | 90 | 5 |
| | 4-2 | 15 | SL-EMS | 85 | 2 |
| | 4-3 | 25 | SL-EMS | 80 | 0 |
| | 4-4 | 30 | SL-EMS | 60 | 0 |
| | 4-5 | 60 | SL-EMS | 30 | 0 |

| | | | | |
|---|---|---|---|---|
| Comparative | 30 | PC-DMC | 5 | 0 |
| Example 3 | | | | |

As shown in Table 4, it was found that, as the percentage of a void was larger, the electric double layer capacitor was able to be prevented from being damaged to a larger extent. In addition, in any of Examples 4-1 to 4-5 according to the present invention, the high-temperature capacity retention rate was 30% or more.

Meanwhile, in Comparative Example 3 in which the nonaqueous solvent was PC-DMC, a large amount of the nonaqueous solvent was evaporated in the preheating step even though no damage was detected. Thus, the high-temperature capacity retention rate was extremely low as 5%.

### Examples 5-1 to 5-4

According to the composition of Table 5, an electrolytic solution was prepared by dissolving SBP-BF₄ into a mixture of a nonaqueous solvent and an organic fluorine compound so as to have a concentration of 1.5 mol/dm³.

Commercial active carbon (specific surface area: 1,900 m²/g, pore volume: 0.85 cm³/g, fine pore ratio: 4%, medium-sized pore ratio: 95%, and number average pore size: 12 μm (measured by a laser mode)) was formed into a disk-shaped plate of 0.2 mm in thickness and 3.95 mm in diameter. The resulting product was used as a test electrode.

1.5 μL of an electrolytic solution of each example were dropped onto the test electrode and a time until the dropped electrolytic solution was absorbed into the test electrode was measured. Visual observation was performed to determine whether the electrolytic solution was absorbed into the test electrode.

In addition, an electric double layer capacitor was obtained in the same manner as in Example 1-1, except that the electrolytic solution of each example was used. The resulting electric double layer capacitor was investigated with respect to its low-temperature capacity retention rate and high-temperature capacity retention rate.

TABLE 5

| | | | Example | | | |
|---|---|---|---|---|---|---|
| | | | 5-1 | 5-2 | 5-3 | 5-4 |
| Nonaqueous | SL | (mass part) | 8 | 8 | 8 | 8 |
| solvent | DMS | (mass part) | 2 | 2 | 2 | 2 |
| Organic | Perfluoro-1,3- | (mass part) | — | 1 | — | — |
| fluorine | dimethyl- | | | | | |
| compound | cyclohexane | | | | | |
| | p-Fluoro- | (mass part) | — | — | 1 | — |
| | toluene | | | | | |
| | Ethyl 4,4,4- | (mass part) | — | — | — | 1 |
| | trifluoro- | | | | | |
| | acetoacetate | | | | | |

| | | | | | |
|---|---|---|---|---|---|
| SBP-BF₄ concentration | (mol/dm³) | 1.5 | 1.5 | 1.5 | 1.5 |
| Impregnation time | (seconds) | 120 | 90 | 90 | 100 |
| Low-temperature capacity | (%) | 80.6 | 84.6 | 86.2 | 83.0 |
| retention rate | | | | | |
| High-temperature capacity | (%) | 80.4 | 84.4 | 86.0 | 81.2 |
| retention rate | | | | | |

As shown in Table 5, the electric double layer capacitors of Examples 2 to 4, which contained organic fluorine compounds, showed shortened impregnation times, as compared to that of Example 1 which did not contain any organic fluorine compound.

In addition, in Examples 2 to 4, the low-temperature capacity retention rate and high-temperature capacity retention rate were higher than that of Example 1.

### Examples 6-1 to 6-5

An electric double layer capacitor was obtained in the same manner as in Example 1-1, except that the separator specification was as shown in Table 6. The resulting electric double layer capacitor was investigated with respect to its high-temperature capacity retention rate.

TABLE 6

| | | | Example | | | | |
|---|---|---|---|---|---|---|---|
| | | | 6-1 | 6-2 | 6-3 | 6-4 | 6-5 |
| Separator | Type | | Fiber | Fiber | Fiber | Fiber | Micropore |
| specification | | | laminate | laminate | laminate | laminate | sheet |
| | Fiber material | | Borosilicate | Borosilicate | Alkali | Alkali | PTFE |
| | | | glass | glass | glass | glass | |
| | Fiber size | (μm) | 0.05 to 10 | 0.05 to 10 | 0.05 to 10 | 0.05 to 10 | Pore size: |
| | Blending | (mass %) | 90 | 90 | 90 | 90 | 0.1 to |
| | amount of | | | | | | 3 μm |
| | fiber | | | | | | |
| | CMC (binder) | (mass %) | 10 | 10 | 10 | 10 | |
| | Thickness of | (μm) | 50 | 50 | 50 | 50 | 50 |
| | intercalated | | | | | | |
| | portion | | | | | | |
| | Thickness of | (μm) | 230 | 160 | 200 | 100 | 50 |
| | periphery | | | | | | |
| | Percentage of | (vol %) | 40 | 61 | 40 | 88 | 40 |
| | void in | | | | | | |
| | intercalated | | | | | | |
| | portion | | | | | | |
| | Percentage of | (vol %) | 87 | 88 | 93 | 94 | 65 |
| | void in | | | | | | |
| | periphery | | | | | | |
| | Separator | | 2.2 | 1.5 | 2.3 | 1.1 | 1.6 |
| | crude density | | | | | | |
| Results | High- | (%) | 75 | 74 | 76 | 73 | 80.6 |
| | temperature | | | | | | |
| | capacity | | | | | | |
| | retention rate | | | | | | |

As shown in Examples 6-1 to 6-4 of Table 6, when the glass fiber laminate was used as the separator, as the separator crude density is higher, the high-temperature capacity retention rate increased more greatly.

What is claimed is:

1. An electrolytic solution for an electric double layer capacitor, comprising:
a supporting electrolyte;
sulfolane; and
a linear sulfone.

2. An electrolytic solution for an electric double layer capacitor according to claim 1, further comprising
an organic fluorine compound.

3. An electrolytic solution for an electric double layer capacitor according to claim 1, wherein:
the supporting electrolyte contains 5-azoniaspiro[4.4]nonane tetrafluoroborate; and
a content of 5-azoniaspiro[4.4]nonane tetrafluoroborate is 1.5 to 3.6 mol/dm³.

4. An electrolytic solution for an electric double layer capacitor according to claim 2, wherein:
the supporting electrolyte contains 5-azoniaspiro[4.4]nonane tetrafluoroborate; and
a content of 5-azoniaspiro[4.4]nonane tetrafluoroborate is 1.5 to 3.6 mol/dm³.

5. An electric double layer capacitor, comprising:
a housing container, comprising a lid and a container body for sealing the housing container,
the housing container comprising:
at least one pair of polarizable electrodes, which are arranged opposite to each other via a separator; and
the electrolytic solution according to claim 1.

6. An electric double layer capacitor, comprising:
a housing container, comprising a lid and a container body for sealing the housing container,
the housing container comprising:
at least one pair of polarizable electrodes, which are arranged opposite to each other via a separator; and
the electrolytic solution according to claim 2.

7. An electric double layer capacitor, comprising:
a housing container, comprising a lid and a container body for sealing the housing container,
the housing container comprising:
at least one pair of polarizable electrodes, which are arranged opposite to each other via a separator; and
the electrolytic solution according to claim 3.

8. An electric double layer capacitor, comprising:
a housing container, comprising a lid and a container body for sealing the housing container,
the housing container comprising:
at least one pair of polarizable electrodes, which are arranged opposite to each other via a separator; and
the electrolytic solution according to claim 4.

9. An electric double layer capacitor according to claim 5, wherein
the housing container has a percentage of a void of 10 to 30 vol %, which is represented by a ratio [(volume of void in housing container)/(capacity of housing container)]×100.

10. An electric double layer capacitor according to claim 6, wherein
the housing container has a percentage of a void of 10 to 30 vol %, which is represented by a ratio [(volume of void in housing container)/(capacity of housing container)]×100.

11. An electric double layer capacitor according to claim 7, wherein
the housing container has a percentage of a void of 10 to 30 vol %, which is represented by a ratio [(volume of void in housing container)/(capacity of housing container)]×100.

12. An electric double layer capacitor according to claim 8, wherein
the housing container has a percentage of a void of 10 to 30 vol %, which is represented by a ratio [(volume of void in housing container)/(capacity of housing container)]×100.

13. An electric double layer capacitor according to claim 5, wherein
the pair of polarizable electrodes comprises an anode side electrode and a cathode side electrode, the anode side electrode having a surface area larger than that of the cathode side electrode.

14. An electric double layer capacitor according to claim 6, wherein
the pair of polarizable electrodes comprises an anode side electrode and a cathode side electrode, the anode side electrode having a surface area larger than that of the cathode side electrode.

15. An electric double layer capacitor according to claim 7, wherein
the pair of polarizable electrodes comprises an anode side electrode and a cathode side electrode, the anode side electrode having a surface area larger than that of the cathode side electrode.

16. An electric double layer capacitor according to claim 8, wherein
the pair of polarizable electrodes comprises an anode side electrode and a cathode side electrode, the anode side electrode having a surface area larger than that of the cathode side electrode.

17. An electric double layer capacitor according to claim 9, wherein
the pair of polarizable electrodes comprises an anode side electrode and a cathode side electrode, the anode side electrode having a surface area larger than that of the cathode side electrode.

18. An electric double layer capacitor according to claim 10, wherein
the pair of polarizable electrodes comprises an anode side electrode and a cathode side electrode, the anode side electrode having a surface area larger than that of the cathode side electrode.

19. An electric double layer capacitor according to claim 11, wherein
the pair of polarizable electrodes comprises an anode side electrode and a cathode side electrode, the anode side electrode having a surface area larger than that of the cathode side electrode.

20. An electric double layer capacitor according to claim 12, wherein
the pair of polarizable electrodes comprises an anode side electrode and a cathode side electrode, the anode side electrode having a surface area larger than that of the cathode side electrode.
